(19) United States
(12) Patent Application Publication
(10) Pub. No.: US 2012/0183366 A1
(43) Pub. Date: Jul. 19, 2012

(54) COMBINATION HOLE SAW ARBOR AND ADJUSTABLE HOLE CUTTER SHAFT

(76) Inventor: Bruce Winter Stenman, (US)

(21) Appl. No.: 13/008,903

(22) Filed: Jan. 19, 2011

(51) Int. Cl. B23B 51/08; B23B 35/00

(52) U.S. Cl. 408/1 BD; 408/20

(57) ABSTRACT

Systems and methods are disclosed to enhance functionality of a power drill, comprising: providing a shaft having one or more threaded sections with different diameters, wherein a pilot bit is inserted into one threaded section; and selectably converting the power drill into either: an adjustable hole cutter by inserting a bar through the shaft, wherein the bar comprises one or more holders to receive cutting blades; or a fixed size hole cutter or hole saw by converting the adjustable hole cutter for use as a hole saw or a hole cutter arbor.

### BACKGROUND

The present invention relates to a combination hole saw arbor and adjustable hole cutter shaft.

Cutters and hole saws are tools used to make cut-outs in a material, such as, for example, wood, steel, fiberglass, and plastic. The hole saw is commonly adaptable to be attached to a hand drill, either power driven or manually operated, in a manner and fashion similar to conventional drill bits and the like. Different styles or sizes of hole saws vary in their mounting configurations, such as the size of the threaded apertures used in coupling the hole saw to the hand drill. For this reason, the tool user often requires an arbor that is specific for each type and/or size of hole saw.

Hole cutters fall into different categories which include hole saws with a saw like edge consisting of multiple teeth, a grit hole saw with a edge that has a hard grit fused to the metal band of the hole cutter, large toothed hole cutters with side slots (gullets) in the barrel. A hole saw is a tool used to make cut-outs in a material, such as, for example, wood, steel, fiberglass, and plastic. The hole saw is commonly adaptable to be attached to a hand drill, either power driven or manually operated, in a manner and fashion similar to conventional drill bits and the like. Different styles or sizes of hole saws vary in their mounting configurations, such as the size of the threaded apertures used in coupling the hole saw to the hand drill. For this reason, the tool user often requires an arbor that is specific for each type and/or size of hole saw.

Adjustable hole cutters are of two types with either one or two cutting blades. With a single blade hole cutter the cutting blade is attached to one end of a bar that can be adjusted for a range of radii (and hole sizes) and it usually requires the use of counterweights to offset the mass of the blade holder and blade. With a twin blade hole cutter there is no need for the counterweights and this results in a simpler and more durable tool. Both types can be used in a pillar or drill press with or without the shield or used with a shield in a hand held electric drill.

U.S. Pat. No. 3,999,869 discloses an arbor for use with different size power tool chuck jaws and has a main body section of enlarged cross section relative to a shank of the arbor. The shank and main body section have a plurality of grooves therein with each groove longitudinally extending the length of the shank and into the adjoining main body section to define a continuous chuck jaw engaging surface which in the main body section of the arbor is of enlarged circumferential dimension relative to that of the shank drive surface for engaging different size chuck jaws in non-slipping positive driving relation.

U.S. Pat. No. 7,104,738 discloses an arbor with a shaft and a locking mechanism operatively coupled to the shaft. The arbor also includes an adapter removably coupled to the shaft by the locking mechanism, the adapter being selectively configurable within the shaft between at least a first operating position, where the adapter is configured to secure a first tool accessory to the arbor, and a second operating position, where the adapter is configured to secure a second tool accessory different at least in part from the first tool accessory.

### SUMMARY

In one aspect, systems and methods are disclosed to enhance functionality of a power drill, comprising: providing a shaft having one or more threaded sections with different diameters, wherein a pilot bit is inserted into one threaded section; and selectably converting the power drill into either: an adjustable hole cutter by inserting a bar through the shaft, wherein the bar comprises one or more holders to receive cutting blades; or a fixed size hole cutter or hole saw by converting the adjustable hole cutter for use as a hole saw or a hole cutter arbor.

In another aspect, a cutting tool to enhance functionality of a power drill includes a shaft having one or more threaded sections with different diameters, wherein a pilot bit is inserted the shaft; wherein the shaft converts the power drill into either an adjustable hole cutter including a bar coupled to the shaft, wherein the bar comprises one or more holders to receive cutting blades or a fixed size hole cutter or hole saw secured to the shaft to convert the adjustable hole cutter for use as a hole saw or a hole cutter arbor.

In another aspect, a cutting tool to enhance functionality of a power drill includes a shaft having one or more threaded sections with different diameters, wherein a pilot bit is inserted the shaft; where the cutting tool converts the power drill into either an adjustable hole cutter including a bar coupled to the shaft, wherein the bar comprises one or more holders to receive cutting blades, or the cutting tool converts the power drill into a fixed size hole cutter or hole saw secured to the shaft that converts the adjustable hole cutter for use as a hole saw or a hole cutter arbor, and all cutting can be done with a protective shield in place mounted using a ball bearing assembly in the center of the shield.

Advantages of the preferred embodiments may include one or more of the following. Single and multiple blade adjustable hole cutters are supported. The system enables the dual use of the shaft for use with an adjustable hole cutter and for use with a hole cutter or hole saw. The system can work with both single blade and two blade adjustable hole cutting tools and tools with and without a shield. The adjustable hole cutter works in conjunction with a shield to contain the cutting debris from the cutting operation of the adjustable hole cutter blade or blades it can also be used to contain the debris and shavings from a cutting operation using a hole cutter or hole saw. Further, the cutting depth of the hole cutting device is regulated by the use of a shield and an adjustment knob on the threaded section of the shaft which limits the penetration of the shaft through the shield and in this manner limits the penetration of the hole saw or hole cutter into the material being cut. In one embodiment, the hole saw can have a steel band with a cutting edge which may consist of many small teeth or may consist of a bonded coating of abrasive grit material, and a hole cutter, which has a steel band that has separate gullets and individually mounted cutting teeth. The new and improved combination arbor which is particularly designed to be used with different size chuck jaws of power tools such as conventional electric drills. The system is capable of withstanding high torque demands without slippage in a compact rugged construction suited to provide reliable service over an extended period of time and which is quickly and easily manufactured at significant cost savings.

### BRIEF DESCRIPTION OF THE DRAWINGS

FIG. 1 shows an exemplary combination hole saw arbor and adjustable hole cutter shaft.

FIG. 2 shows an exemplary hole saw mounted to the shaft and without bar and blade holders.

FIG. 3 shows a standard adjustable hole cutter assembly with the shaft of FIG. 1.

FIG. 4 shows an exemplary fully assembled adjustable hole cutter and shield.

FIG. 5 shows in more details the end of shaft that is designed to provide for attachment of pilot bit, bar, and two different thread mount sizes of hole cutters.

FIG. 6 shows exemplary blade holders with the blades removed to allow for unimpeded full cutting depth of the hole cutter.

FIG. 7 shows an exemplary single blade cutter.

### DESCRIPTION

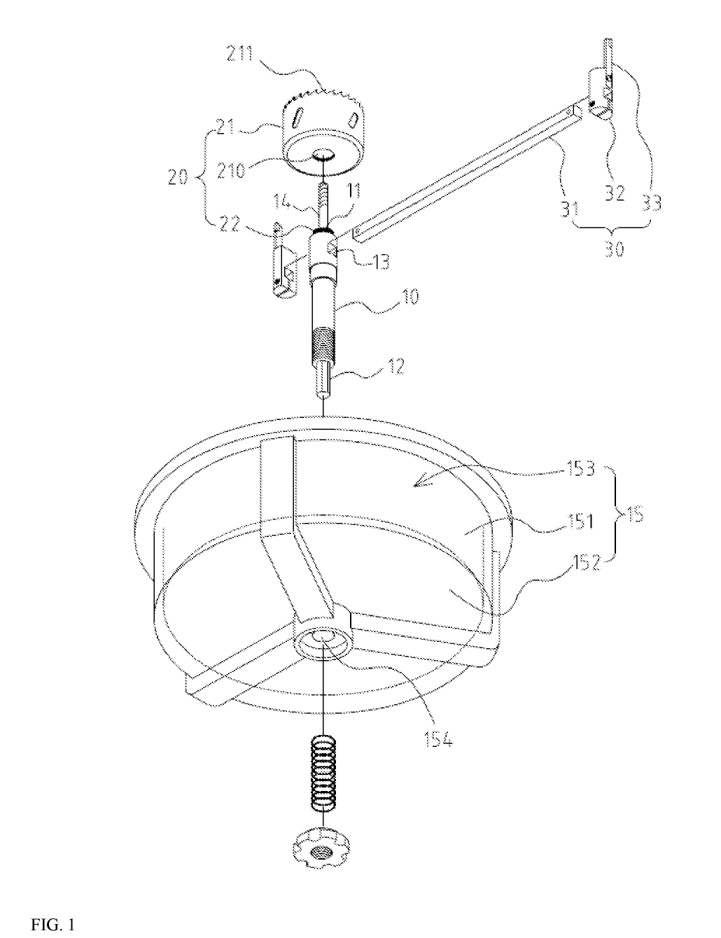

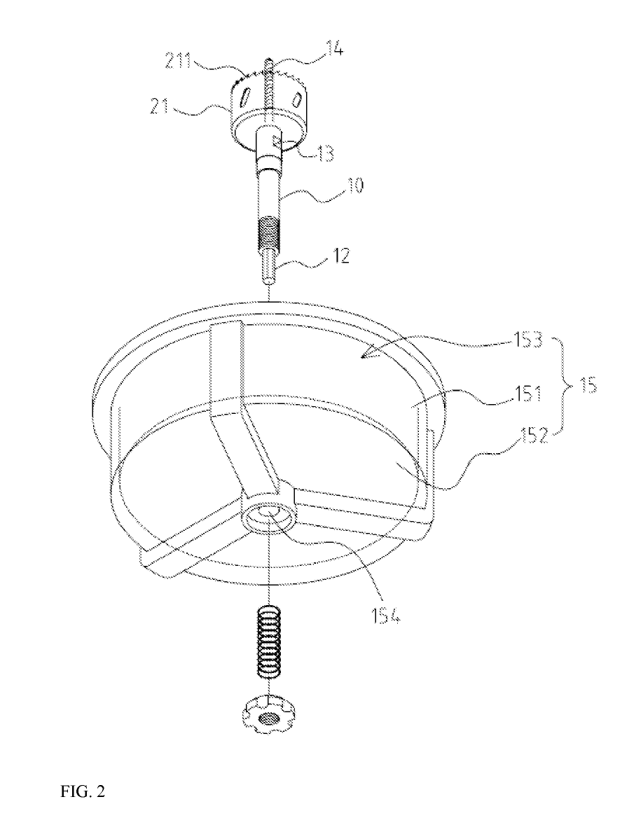

FIG. 1 shows an exemplary combination hole saw arbor and adjustable hole cutter shaft, while FIG. 2 shows an exemplary hole saw mounted to the shaft and without bar and blade holders. FIG. 2 shows that the cutting tool can selectably convert the power drill from the adjustable hole cutter mode into a fixed size hole cutter or hole saw by converting the adjustable hole cutter for use as a hole saw or a hole cutter arbor.

In FIG. 1, a protection cowl 15 includes a shield top 152 and a shield side 153 with a shield height 151 that determines the maximum cutting depth possible while using the shield. An optional rubber pad support can be mounted on the protection cowl 15 to prevent scratching or damaging the surface being cut. A shaft body 10 includes a shaft shank 12. The shaft 10 is used to hold a tangential bar with one or more holders for cutting blades with the bar adjustable to enable cutting of holes of varying diameters by adjusting the position of the blade holder for the cutting blades relative to the center axis of the shaft. Preferably, the shaft 10 is machined so that its outside diameter will fit inside the ball bearing insert of the shield. The shaft 10 has a center bore for inserting a pilot bit to restrict horizontal movement of the hole cutting blades. This bore has a perpendicular threaded hole to permit the use of a screw to prevent movement of the pilot bit independent of the shaft. The shaft's shank 12 supports for gripping by a drill chuck, among others. The protective cowl 15 is secured to the shaft shank 12 using a suitable gearing screw and a compression spring. The shaft body 10 is adapted to be inserted into the protective cowl 15 through a ball bearing insert 154 that permits the shaft 10 to rotate while the shield remains stationary. The shaft body includes an aperture 13 for inserting and mounting a measurement bar 30 there through. The measurement bar 30 includes a bar member 31 that supports blade holders 32 at each end of the bar member 31. The positions of blade holders 32 determine the size of hole that will be cut. A cutting blade 33 projects from each blade holder 32 to cut the hole. The blade holders 32 can be loosened and moved to any location along the bar and which supports the cutting blade 33.

The system of FIG. 1 also includes a hole cutter 20 with a band steel side 21 and cutting teeth 211 of the hole saw in the hole cutter. Teeth 211 could be tooth or carbide or diamond grit. The shaft 10 can be connected to a hole cutter 20 through a threaded section 22 of the shaft 10 to which hole cutter 20 is mounted. A pilot bit 14 is provided to laterally stabilize the hole cutter of FIG. 1 while it is rotating and cutting. The pilot bit 14 mounts into aperture 11 bored into the shaft 10. In one embodiment, the mounting is achieved through a pilot bit 14 that is secured to an aperture 11 in the shaft 10 to receive the pilot bit 14. An aperture 210 is positioned on the hole cutter 20 for mounting hole cutter 20 to the threaded section 22 of the arbor adapter. The added threaded section at the end of the shaft where the pilot bit is inserted can be used to secure a fixed size hole cutter or hole saw at its base. This enables the same shaft to be used for an adjustable hole cutter and for use as a hole saw or hole cutter arbor for use with any power drill.

The system of FIG. 1 applies to single as well as twin blade hole cutters, each of which employs a central shaft and a bar that provides for adjusting the radius of the hole cutter's blade or blades. The hole cutter shaft supports the bar and the pilot bit and with the system of FIG. 1, supports a fixed size hole cutter. The standard practice has been to use a hole saw arbor adapter with a ½″-20 thread for hole cutters smaller than 1⅛ inch diameter and a separate arbor adapter with a ⅝″-18 thread for larger sizes of hole cutters. The system of FIG. 1 includes the use of a dual threaded section that provides for attaching either a ½″-20 or a ⅝″-18 threaded hole saw to the single shaft which then serves as an arbor adapter for use by a drill.

FIG. 2 shows the shaft being used to convert the power drill into a fixed sized hole cutter. In this mode, the blades of the adjustable hole cutter are removed and only the hole cutter 20 remains. In this manner, the shaft adapts the power drill into a fixed size hole cutter or hole saw by converting the adjustable hole cutter for use as a hole saw or a hole cutter arbor.

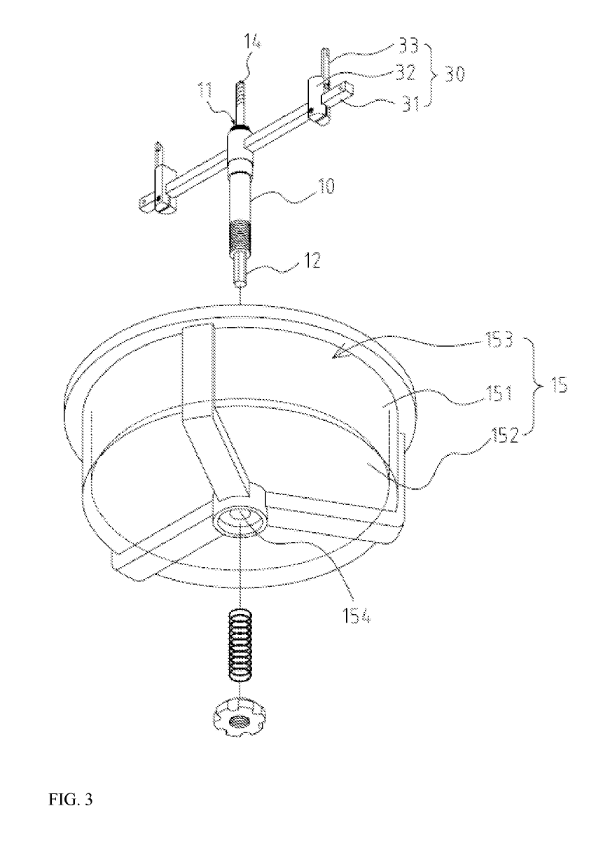

FIG. 3 shows a standard adjustable hole cutter assembly with the shaft of FIG. 1, while

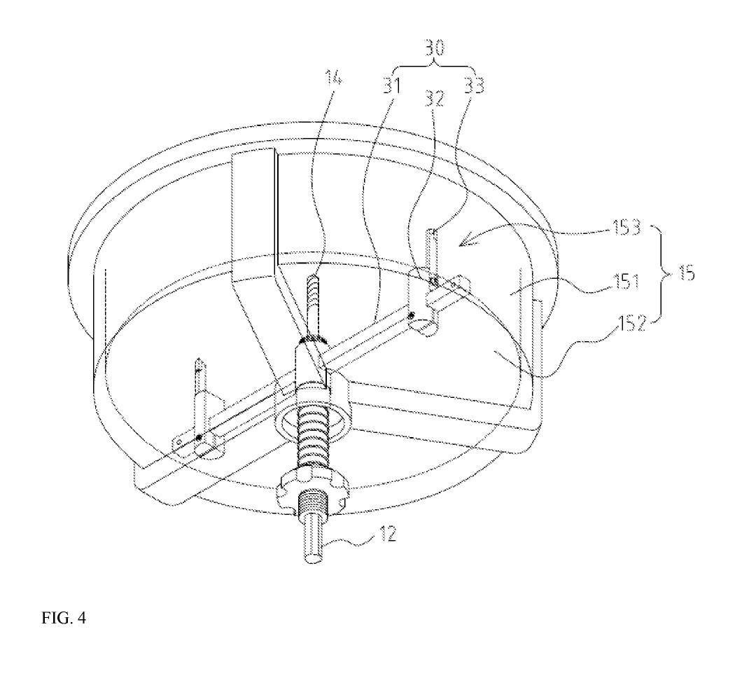

FIG. 4 shows an exemplary fully assembled adjustable hole cutter and shield. The embodiment of FIG. 4 shows that adjustment can be made to the blade holders 32 to change cutting radius of the tool's blades (twin blade model). The system enables the dual use of the shaft for use with an adjustable hole cutter and for use with a hole cutter or hole saw. The system can work with both single blade and two blade adjustable hole cutting tools and tools with and without a shield. The adjustable hole cutter works in conjunction with a shield to contain the cutting debris from the cutting operation of the adjustable hole cutter blade or blades it can also be used to contain the debris and shavings from a cutting operation using a hole cutter or hole saw. Further, the cutting depth of the hole cutting device is regulated by the use of a shield and an adjustment knob on the threaded section of the shaft which limits the penetration of the shaft through the shield and in this manner limits the penetration of the hole saw or hole cutter into the material being cut.

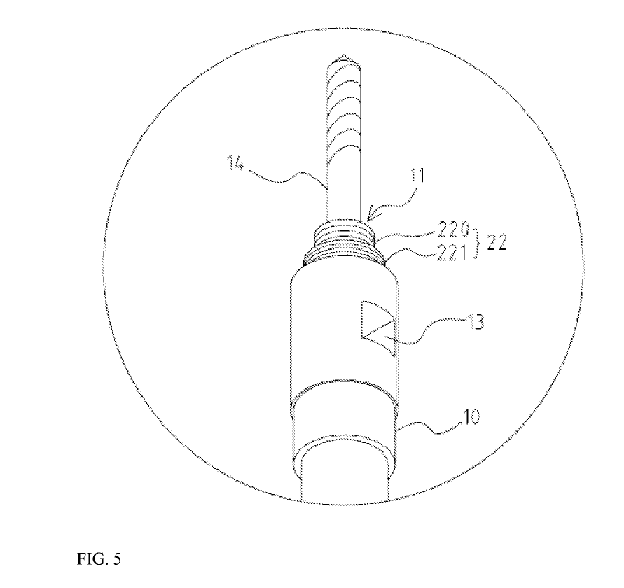

FIG. 5 shows in more details the end of shaft that is designed to provide for attachment of pilot bit, bar, and two different thread mount sizes of hole cutters. Dual threads 22 are used which to avoid the need to use two different arbors for the different mount sizes. In FIG. 5, threaded section 220 can include (½″-20) threads for small hole saws. A second threaded section 221 can be used and may be (⅝″-18) for hole saws 1⅛″ diameter and larger. This embodiment with two threaded sections of different diameters allows the user to use a small hole cutter with a ½″ thread mounting and a large hole cutter with a ⅝″ thread mounting, for example, on a single shaft with no additional parts or adapters needed. In contrast, prior work has entailed adapters to convert the end of an arbor for a different size mountings.

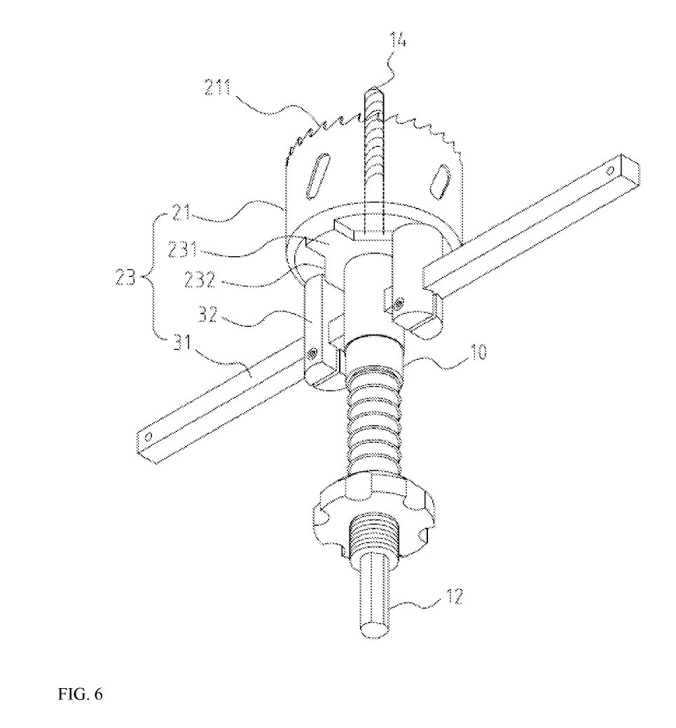

FIG. 6 shows exemplary blade holders with the blades removed. The 2 blades attached to the moveable blade holders would each be removed prior to cutting with the hole saw or hole cutter. The system of FIG. 6 allows the full cutting depth of the hole cutter without being impeded. With a single blade adjustable hole cutter, the blade would also be removed to maximize the height of the hole cutter and the maximum cutting depth possible. The maximum cutting depth would be limited only by the hole saw or hole cutter or the depth of the shield, depending on which one is used.

FIG. 6 shows that the cutting tool can selectably convert the power drill from the adjustable hole cutter mode into a fixed size hole cutter or hole saw by converting the adjustable hole cutter for use as a hole saw or a hole cutter arbor.

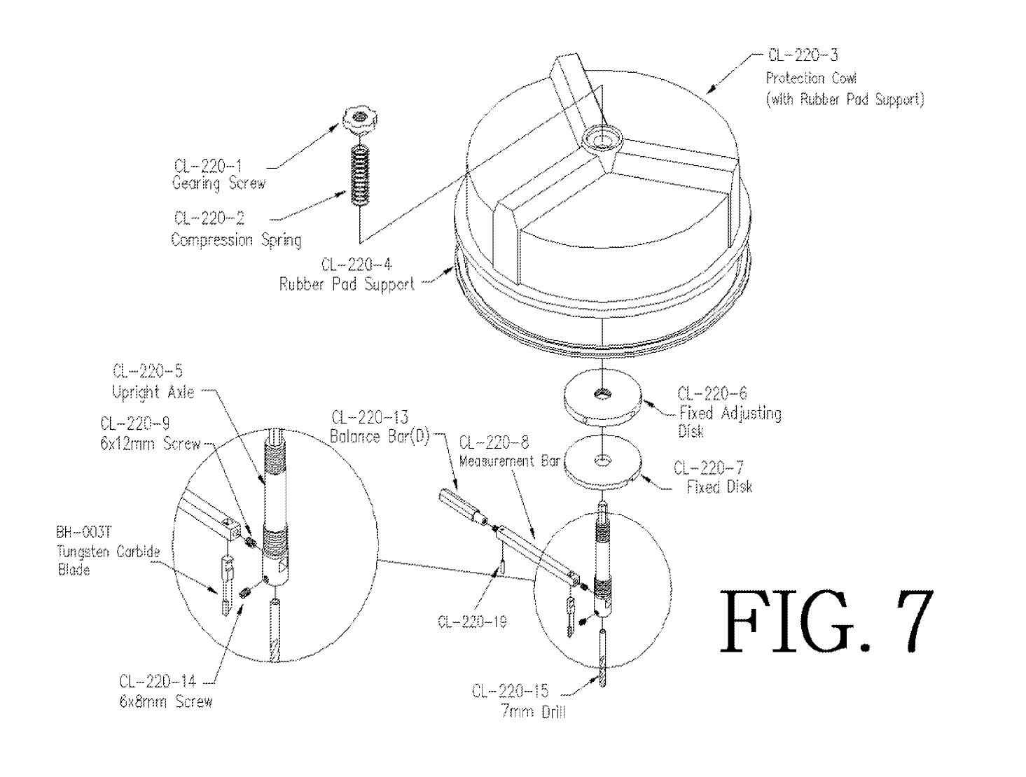

FIG. 7 shows an exemplary single blade cutter. In this embodiment, a protection cowl or shield CL-220-3 is provided with an rubber pad support CL-220-4 at the bottom of the cowl or shield. A gearing screw CL-220-1 secures a compression spring CL-220-2 to the cowl CL-220-3 and the shaft with an axle CL-220-5. A measurement bar CL-220-8 is secured to the axle CL-220-5 by a suitable attachment CL-220-9 such as a screw, among others. A balance bar CL-220-14 can be attached to one end of the measurement bar CL-220-8. A blade BH-003T such as a tungsten carbide blade is connected to the measurement bar CL-220-8. Additionally, another attachment CL-220-14 secures a drill bit CL-220-15 to the axle CL-220-5. The measurement bar CL-220-8 can be mounted directly to the cowl CL-220-3 or alternatively can be mounted through a fixed disk CL-220-7 and a fixed adjusting disk CL-220-6.

A reference list of the elements used in the above embodiments is as follows:

| Number | Description |
|---|---|
| 211 | Cutting teeth of hole saw—could be tooth or carbide or diamond |
| | grit |
| 21 | Band steel side of the hole cutter |
| 210 | Aperture for mounting hole cutter—threaded for arbor adapter |
| 22 | Threaded section of the shaft to which hole cutter is mounted |
| 11 | Pilot Bit mounts into aperture bored into the shaft |
| 13 | Aperture for mounting a bar (No. 31) that supports blade holder |
| | (No. 32) |
| 10 | Shaft body |
| 12 | Shaft's shank for gripping by a drill chuck |
| 31 | Bar that supports blade holders—position of blade holder |
| | determines size of hole that will be cut |
| 32 | Blade holder which can be loosened and moved to any location |
| | along the bar and which supports the cutting blade (No. 33) |
| 33 | Cutting blade for adjustable hole cutter |
| 153 | Side of shield—height determines maximum cutting depth |
| | possible while using the shield |
| 151 | Shield |
| 152 | Top of shield |
| 154 | Ball Bearing Insert which permits shaft to rotate while the shield |
| | remains stationary |
| 14 | Pilot Bit |
| 220 | Threaded section (½″-20) for small hole saws |
| 221 | Threaded section (⅝″-18) for hole saws 1⅛″ diameter and |
| | larger |

The hole cutter is well suited to cutting very hard materials such as ceramic tiles. With these materials a tungsten carbide grit or a diamond grit hole cutter is used. The edge may have a saw type edge or a blunt square tooth edge or a continuous rim of grit bonded to it depending upon the application requirements. The arbor adapter converts the cowls or shields for use with hole cutters. This embodiment permits users to make use of their adjustable hole cutter shaft and shield without need for the XL Arbor Adapter when cutting holes of less depth.

It will be seen that the above embodiments can be used in electric drills with ¼ inch, ⅜ inch and ½ inch or larger capacity chucks, e.g., and will be used for driving a variety of different size hole saws, such as 9/16 inch to, say, 8 inch hole saws for different cutting applications in various materials such as plastic, wood and metal. Moreover, the system is quick to assemble and easy to manufacture and assemble to achieve the desired cost savings.

While the preferred embodiment of the invention has been illustrated and described, it will be appreciated that various changes can be made therein without departing from the spirit and scope of the invention.

What is claimed is:

1. A hole cutting tool to enhance functionality of a power drill, comprising:
a. a shaft having one or more threaded sections with different diameters, the shaft being adapted to receive a pilot bit;
b. wherein the shaft converts the power drill into either:
i. an adjustable hole cutter by inserting a bar through the shaft, wherein the bar comprises one or more holders to receive cutting blades; or
ii. a fixed size hole cutter or hole saw by converting the adjustable hole cutter for use as a hole saw or a hole cutter arbor.

2. The tool of claim 1, wherein the shaft comprises two threaded sections with different diameters to receive two different hole saws or hole cutter arbors.

3. The tool of claim 1, wherein each holder on the bar is adjustable relative to a center axis of the shaft to enable cutting of holes of varying diameters.

4. The tool of claim 1, wherein the shaft has a center bore for inserting the pilot bit to restrict horizontal movement of one or more hole cutting blades.

5. The tool of claim 4, wherein the center bore has a perpendicular threaded hole receiving a screw to prevent movement of the pilot bit independent of the shaft.

6. The tool of claim 1, wherein the shaft supports a single blade adjustable hole cutting option and a two blade adjustable hole cutting option.

7. The tool of claim 1, comprising a protective shield or cowl to contain cutting debris.

8. The tool of claim 1, comprising a protective shield or cowl with a ball bearing insert to insure a perpendicular hole is cut into the material.

9. The tool of claim 1, wherein a cutting depth of the cutter is regulated with a shield.

10. The tool of claim 9, wherein a cutting depth of the cutter is regulated by an adjustment knob on the threaded section of the shaft to limit penetration of the shaft through the shield.

11. The tool of claim 1, comprising one or more cutting blades, each coupled to the holders to cut material, wherein the holders on the bar are adjustable relative to a center axis of the shaft to cut holes of varying diameters.

12. A method to enhance functionality of a power drill, comprising:
a. providing a shaft having one or more threaded sections with different diameters, wherein a pilot bit is inserted into an end of a threaded section; and
b. selectably converting the power drill into either:
i. an adjustable hole cutter by inserting a bar through the shaft, wherein the bar comprises one or more holders to receive cutting blades; or
ii. a fixed size hole cutter or hole saw by converting the adjustable hole cutter for use as a hole saw or a hole cutter arbor.

13. The method of claim 12, comprising
a. inserting a bar into the shaft, wherein the tangential bar comprises one or more holders for cutting blades; and
b. adjusting each holder on the bar relative to a center axis of the shaft to enable cutting of holes of varying diameters.

14. The method of claim 12, comprising inserting a pilot bit into a shaft center bore restrict horizontal movement of one or more hole cutting blades.

15. The method of claim 15, wherein the bore has a perpendicular threaded hole to permit a screw to prevent movement of the pilot bit independent of the shaft.

16. The method of claim 12, wherein the shaft supports a single blade adjustable hole cutting option and a two blade adjustable hole cutting option.

17. The method of claim 12, comprising mounting a protective shield or cowl to contain cutting debris.

18. The method of claim 12, comprising regulating a cutting depth with a shield.

19. The method of claim 18, wherein a cutting depth of the cutter is regulated by an adjustment knob on the threaded section of the shaft to limit penetration of the shaft through the shield.

20. The method of claim 12, comprising:
a. mounting a bar on the shaft,
b. positioning one or more holders on the shaft,
c. placing a cutting blade on each holder to cut material, and
d. adjusting each holder on the bar to enable cutting of holes of varying diameters.
